(19) United States
(12) Patent Application Publication
(10) Pub. No.: US 2014/0169922 A1
(43) Pub. Date: Jun. 19, 2014

(54) CART WITH LIFTING SYSTEM AND OMNIDIRECTIONAL WHEELS

(71) Applicants: Frank Charles Cozza, Santee, CA (US); Gerry H. Taylor, Carlsbad, CA (US)

(72) Inventors: Frank Charles Cozza, Santee, CA (US); Gerry H. Taylor, Carlsbad, CA (US)

(21) Appl. No.: 14/133,543

(22) Filed: Dec. 18, 2013

Related U.S. Application Data
(60) Provisional application No. 61/738,964, filed on Dec. 18, 2012.

(51) Int. Cl. B66F 7/14

(52) U.S. Cl. CPC B66F 7/14
USPC 414/495

(57) ABSTRACT

A cart for transport of heavy objects is provided. The cart has a frame supported by four omnidirectional wheels above a support surface. The frame may be adapted with a lift mechanism configured to lift a planar top surface, or, a piece of machinery adapted to engage with the lift mechanism. The omnidirectional wheels allow for movement of the cart in any direction by pushing in that direction.

### BACKGROUND OF THE INVENTION

1. Field of the Invention

This application claims priority to U.S. Provisional Patent Application Ser. No. 61/738964 filed on Dec. 18, 2012, and by this reference includes herein the entire specification and all drawings therefrom.

The present invention relates to carts employed for carrying and transport of items and equipment as well as such a cart with an onboard lifting system. More particularly, it relates to a cart having omnidirectional wheels which is adapted for carrying and lifting heavy objects and which additionally provides a means for monitoring usage through the employment of an onboard sensor. Using the sensor usage information can be determined and reviewed subsequent to use, for mitigating wrongful and unsafe use. The usage information can be communicated to a wireless device, such as a smart phone or over a computer network, to allow for tracking and monitoring of each instance of use. Such use information can also be communicated over a wired or wireless network to a server for storage in a cloud allowing data acquisition concerning device use, at a later date.

2. Prior Art

Carts are employed for transport of many items in the home, businesses and in industrial applications. Such carts conventionally employ wheels which roll along a single axis and are moveable in a linear or curved path. Frequently such carts are employed to move heavy machinery. For example large commercial dish washing machines, often referred to as dishmachines, are an everyday tool commercially employed in many industries and homes and for example in virtually all food service industries such as restaurants, catering, and fast food establishments for example. Such machines substantially reduce the time and cost associated with washing dishware, cooking utensils, and tableware. Additionally, their use provides a more sanitary and eco-friendly solution to the commercial cleaning of food preparation and eating utensils.

Dishmachines are built for and intended for high volume cleaning cycles, with rapid turnover and low energy consumption so that restaurants and the like, can continually wash and produce clean and sanitized tableware such as dishes and silverware and glasses. In a restaurant setting, such dishmachines are typically positioned out of the flow of cooking traffic and as such, against a wall or corner where the machine will be out of the way however easily accessible to the cleaning staff.

Due to the high volume cleaning intended, these machines, are typically manufactured relatively large. For example, the E-S 2000 Dishmachine by ECOLAB® has a footprint of about 4-5 square feet, and is nearly six feet tall. This commercial machine, and most similar constructed dish washing machines conventionally include a washing unit which is raised and supported above the ground by structural support weldment. The weldment conventionally comprises a plurality of vertical support legs, and horizontal crossbars extending between engagement and support of the legs, for providing rigidity.

This structural support, being generally metal, along with the substantially metal formation of the washing unit itself, combine weights to render the dishmachine heavy. A vexing problem of such machines, by nature of their girth and substantial weight is the transportation and positioning of them to a final location within a kitchen, or other desired location. Additionally, kitchens must be kept exceptionally clean to avoid disease, and lifting of such machines to allow for cleaning and rodent inspection underneath, also has weight related problems.

Typically, manufacturers and/or distributors will ship such heavy equipment items secured to a conventional wooden pallet. On arrival, a conventional pallet jack and/or fork lift may be employed for moving the dishmachines in and out of shipping containers and shipping trucks.

However, just like most heavy items of equipment or objects, before being positioned into a final location, the machine must be moved into close quarters where turning and locating it is hard to do. Then it must be raised above and off the shipping pallet and additionally transported and lowered in a position of its final location. Currently, there exists no unified or standardized system having a cart which also employs components, to lift, move, and subsequently place the dishmachine in position, nor to lift it for service or cleaning thereafter. Further even carts without lifting capability have single direction wheels which offer no aid in maneuvering in tight quarters. Instead, users may attempt to employ human power to lift and to move these heavy objects such as commercial machines which is however unsafe. Because of the weights involved, and the bulk and the confined space, using humans for lifting moving without proper tooling, results in much time wasted.

Alternatively, forklifts have been employed to lift these heavy items and machinery and position them, however is not typically recommended through the instituted safety protocols, since the machines are not generally configured to receive the forklift forks in a secured and steady engagement. Further, in the confines of a kitchen, forklifts rarely are accommodated.

This is especially true when the moving of equipment is required during the remodeling or renovation of restaurants, stores, homes and the like. During such a remodeling process, it is often necessary to move large objects, construction materials and the large machines and other equipment. Moving them generally requires repositioning the dishmachines from one part of the venue to another. Often during a remodeling process, the restaurant or vendor may wish to remain open and in operating condition such that the heavy objects are hard to move without causing problems. For instance, a dishmachine cannot be dismantled and may in fact may need to be up and running in a short amount of time. Further, the dishmachines may need to be moved multiple times to allow for various phases of construction and repositioning to new locations.

Due to the inherent dangers associated with lifting and transporting such heavy objects, large amounts of lighter objects, and machines, and lack of a unified system of components, to move them and preferably to also lift them, large equipment manufactures and even homeowners often encounter workers compensation litigation related to injuries during such lifting and moving procedures. A great deal of time and money is therefor spent to determine if proper equipment and safety protocols were followed.

As such, there is a continuing unmet need for an improved carting device that provides for easy, quick, and safe movement of heavy loads, equipment, and similar equipment and items. Such a device should be endowed with wheels allowing multiple directional pushing and pulling of the cart. Such a device should provide a means for monitoring usage as needed for mitigating improper and unsafe use. Such a device should be easily adapted to the job at hand and type of equipment involved. Still further, such a device should provide a cart which will carry heavy loads in various directional paths and optionally lift them at the destination and should be safe to use for workers and should curtail accidents by preventing tipping of the heavy dishmachine when lifted and transported.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals through the provision of a cart device having a planar top surface for easy accommodation of product transport and in a preferred mode, provides an adaptive lifting and transportation system. In one particularly preferred mode the device provides a means for secured supportive engagement and stabilized lifting in combination with an engagement with the conventionally employed crossbars of the support structure of the dishmachine which supports the load of the washing unit.

Further the disclosed method and device can be adapted for engaging with most machinery such as a dishmachine while the dishmachine is still engaged in shipping position to a pallet. Thus, the device is especially well adapted to both wheeled transport and with the heavy lifting task at hand. The omnidirectional wheels render the device especially easy to move even in confined spaces. It thus provides both a means for transporting objects and lifting them on a rising top surface or just transporting them. When used to move machinery such as a dishmachine, it can be engaged to lift the dishmachine off the pallet, and a means for its safe transportation thereafter and a lowering into a confined operating space at the machine's final location.

However, it is noted that the device herein in a simple form, employs a planar transport surface atop a frame having omnidirectional wheels. The wheels rotate along perpendicular axis such that they may roll sideways and forward and rearward making movement in confined spaces easier. Further, the planar transport surface may be engaged to an underlying lift engaged between the frame of the cart and the surface. Still further, the device can be adapted by removal of the planar surface, to engage any other type heavy machinery which include a similar or suitable equivalent of a structural support weldment as described above, and to monitor and track their use. As such, those skilled in the art will recognize the slight or moderate modifications to the device which may be needed to adapt the cart device herein for rolling transport and engaging and lifting types of heavy objects and machinery having slightly or moderately modified structure supports than those of the conventional dishmachine.

In at least one preferred mode, the device is provided in the form of a omnidirectional wheeled handcart. The handcart includes a base frame supported by a plurality of omnidirectional wheels and having a removably engageable push handle. Means for lifting either a surface or an object is provided by a lift mechanism such as a screw operated scissor jack lift system preferably comprising four scissor jack type lifts.

The scissor jack lifts providing a lift mechanism are engaged to the base frame and can be engaged with a planar top to lift it, or directly with a heavy object adapted for engagement. Raising and lowering of the jacks is provided by rotating the screw in either direction accordingly. Currently, a hand operated crank engaged to the screw provides a means for rotating the screw. However, it is noted that other means for rotating may be employed, such as an electric motor, or other suitable means.

There are included slidably engaged support rails engaged to the upper ends of the scissor jacks which include static support saddles configured to engage the horizontal crossbars of the structural support weldment of the dishmachine. The support rails and saddles provide points of engagement with dishmachine and evenly distribute the weight onto the jacks.

Thus, the device can be positioned under heavy equipment such as a dishmachine, or other type heavy machinery, and by aligning the crossbars with the support saddles, the dishmachine can be safely lifted through operation of the scissor jacks. In particular, the saddles are formed from plastic and include a concave recess which is adapted to cradle the typically round crossbars of the support weldment for a secured and stabilized engagement during lifting and lowering.

It is noted however, that the support provided by the support saddles engaged upon the support rails is intended only for the vertical lifting or lowering of the dishmachine, and is not intended to provide the sole support while moving a dishmachine engaged upon the device, and is considered a safety protocol within the operation of the device. As such, additional stabilized support means are also provided and intended to be employed when transporting the dishmachine when engaged upon the device. Current, stabilized support means are provided by one or a plurality of rigid supports which are slidably engaged to the base frame, adjacent the scissor jacks.

It is intended that once lifted via the scissor jacks in order to remove the pallet, the slidable supports can be positioned such that when the dishmachine is then lowered, the crossbars are supported by the slidable supports, and not just the jacks. As such the slidable supports are preferably formed as reinforced and rigid durable bodies which can support the heavy weight of the dishmachine. In addition to providing stabilized support means during transportation, the slidable supports allow the weight of the dishmachine to be temporarily taken off the scissor jacks, which provides a means for ensuring a longer operable life of the scissor jacks.

Further, a particularly preferred feature of all modes of the device is a means to mitigate user injury and ensure proper protocol is followed, preferably through the employment of a sensors for usage monitoring of the device. Currently, the means for usage monitoring is intended to track usage data including but not limited to, when the device is used, how long it is used for, if correct safety protocols where followed (i.e. proper use of the slidable supports during transportation), and determine the need for maintenance on the device.

In a particularly preferred mode, the device is assigned an identifier such as an identification serial number or the like, which is linked in a relational database stored in a computer or server memory, accessible to the user or purchaser, prior to and during deployment and an intended operation of the device. Means for linking the device to the user can be provided by a RF transmitter, microchip, an RFID, a bar code, or preferably a quick response (QR) code which can be scanned and stored into a user's handheld electronic device, such as a smart phone.

Using software running on a computing device which is adapted for communicating over a wired or wireless network, once linked, this user and usage data can be stored in electronic memory such as in a smart phone and sent over a wireless network to a remote server for use data storage in computer memory and retrieval if needed for billing or for safety review of the data concerning operative use of the device.

In addition, sensing means, such as one or combination of an electronic optical, position, and/or load sensors, can be incorporated into the hand crank and screw to measure the operation of the scissor jacks, including but not limited to, the date/time of operation, the distance raised or lowered, and the load supported by the scissor jacks. This data may be stored in an onboard memory of an onboard computing device. The onboard computing device may also employ a wireless network enabled communication means to send this data to the remote server.

In use, the remote server may be accessible to large equipment manufactures who encountered law suits regarding workers compensation injuries related to lifting and transporting heaving equipment, such that they can retrieve usage data of the device employed to move such large equipment, and confirm if protocol was followed. For example, the monitoring means can be employed to determine if the device was for instance transported while the dishmachine was still supported by the scissor jacks, and not the sliding supports, as is considered proper safety protocol when using the device.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a perspective view of a particularly preferred mode of the device substantially being a wheeled handcart employing means for stabilized lifting and secured supportive engagement of the crossbars of the support structure of a large commercial dishmachine.

FIG. 1a shows a detailed view of the hand cranch and screw employed for operating a plurality of scissor jacks employed as a lifting means.

FIG. 2 shows a side view of the device with the scissor jacks in a lowest position.

FIG. 3 shows a side view of the device with the scissor jacks in a highest position.

FIG. 4 shows a view of the device and a conventional commercial dishmachine which is typically shipped to the purchaser on a pallet.

FIG. 5 shows the device in the as used mode for lifting the dishmachine off of the pallet.

FIG. 6 shows the device in the as used mode with the pallet removed and the dishmachine lowered onto the slidable supports as needed for transportation.

FIG. 6a shows a detailed view of a safety release knob which can be disengaged to allow the slidably engaged support rails which support the dishmachine atop the scissor jacks to translate as needed for positioning the dishmachine prior to lowering it to its final location.

FIG. 7 depicts a mode of the device having a cart with omnidirectional wheels and a planar top, which may be engaged with the lift as in FIG. 5 or stationary.

FIG. 7a shows the omnidirectional wheels.

FIG. 8 depicts a mover's dolly type cart device having a planar surface and omnidirectional wheels.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

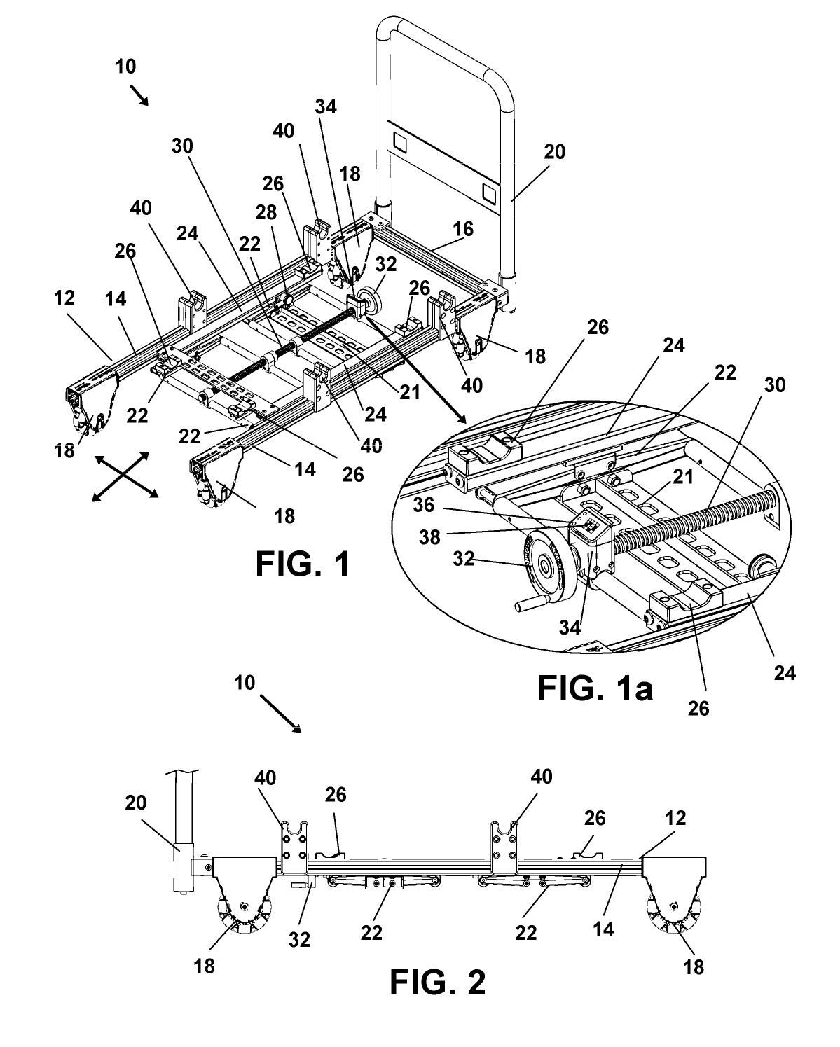

Now referring to drawings in FIGS. 1-7, wherein similar components are identified by like reference numerals, a particularly preferred mode of the device 10 herein disclosed features a cart system having omnidirectional wheels 18 configured to provide a means for secured supportive engagement and means for stabilized lifting of commercial objects and machines adapted to engage with it such as dishmachines or other suitably adaptable machinery.

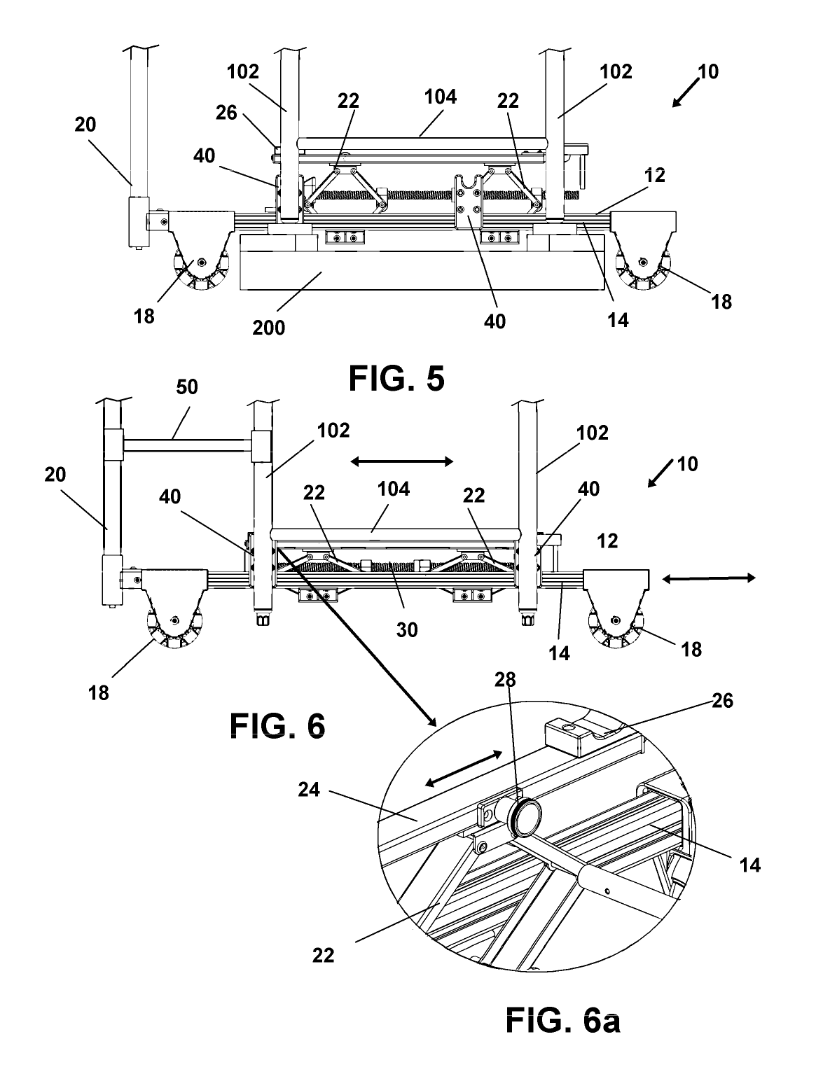

The device 10 is adapted to engage a structural support weldment of the commercial dishmachine 100 or other adaptable piece of machinery comprising a plurality of vertical support legs 102, and horizontal crossbars 104, or suitable equivalent structural support weldment. Such horizontally disposed crossbars 104 are generally positioned above the ground to allow for the communication of the device 10 under the crossbars 104 in the as used mode for lifting (FIG. 5). As such, moving such dishmachines 100 with the device 10 herein entails aligning the device 10 under the crossbars 104 for lifting the dishmachine 100 and removing the shipping pallet 200 if present. The device 10 has a plurality of omnidirectional wheels 18 which allow for omnidirectional transportation of the carried load to the desired location.

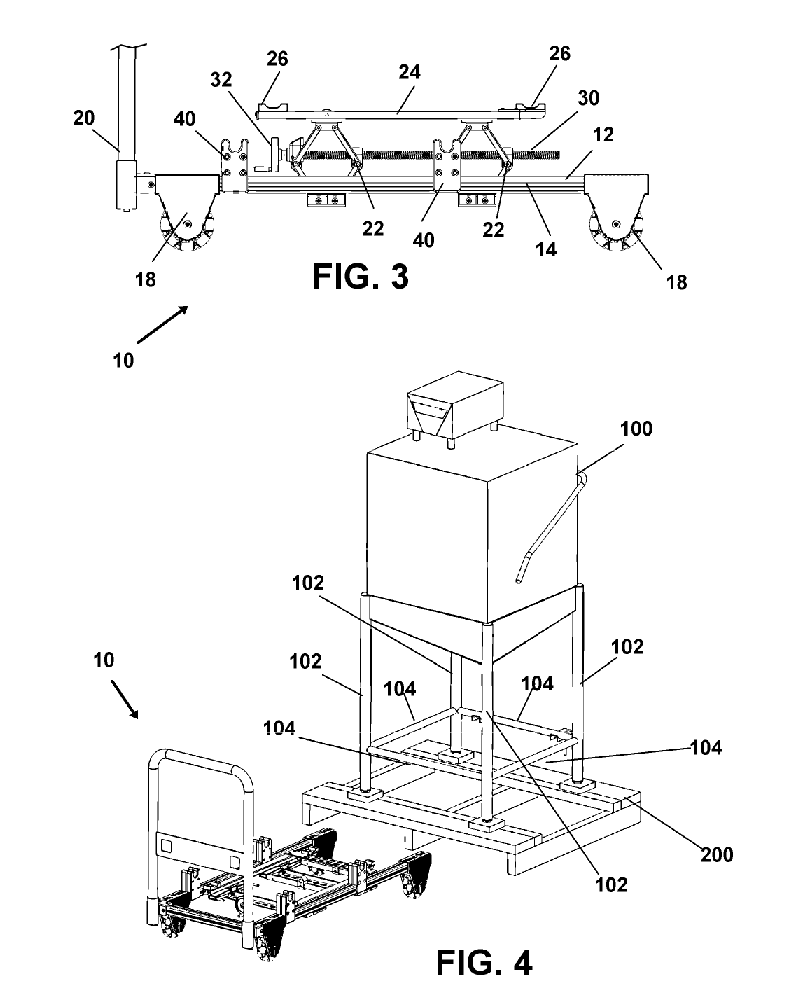

In accordance with at least one preferred mode, and shown in FIG. 1, FIG. 1a, FIG. 2, and FIG. 3, the device 10 is provided in the form of a wheeled handcart including a rigid base frame 12 comprised of two side support rails 14 and a rear crossbar 16. The base frame 12 is supported by a plurality of omnidirectional wheels 18. A removably engageable push handle 20 is provided.

Means for stabilized lifting is provided by a screw operated scissor jack lift system preferably comprising four scissor jack type lifts 22 engaged to the base frame 12 via support cross bars 21 extending between the side support rails 14. Raising and lowering of the jacks 22 is provided by a screw 30 engaged to the jacks 22 through conventional linkage. By rotating the screw 30 in the suitable direction, the user is provided with a means for driving the raising and lowering operation of the jacks 22 in unison. Currently, a hand operated crank 32 is engaged to a proximal end of the screw 30 provides a means for rotating the screw. However, it is noted that other means for rotating may be employed, such as an electric motor, or other suitable means. FIG. 2 and FIG. 3 show the jacks 22 raised to various elevated positions.

There are included support rails 24 which are slidably engaged to the upper ends the scissor jacks 22. The support rails 24 include a plurality of static support saddles 26 which are configured to engage the horizontal crossbars 104 of the structural support weldment of the dishmachine 100 as shown in FIG. 5. In particular, the saddles 26 are formed from plastic and include a concave recess as can be seen, which is adapted to cradle the typically round crossbars 104 of the support weldment as a means for secured and stabilized engagement during lifting and lowering of the dishmachine 100. It is preferred that the support rails 24 can be non-slidably affixed to the scissor jacks 22 during lifting, to provide stability during lift. Currently, a safety release knob 28 (FIG. 6a) is provided and employed to secure the support rails 24 to the jacks 22, however can be pulled to disengage the support rails 24 and allow them to slide relative the jacks 22.

In use, the device 10 is positioned under the dishmachine 100, and over a shipping pallet 200 if present, with the crossbars 104 aligned with the support saddles 26, the dishmachine 100 can be safely lifted through operation of the scissor jacks 22, and the pallet removed 200. It is again noted however, that the support provided by the support saddles 26 engaged upon the scissor jacks 22 is intended only for the vertical lifting or lowering of the dishmachine 100, and is not intended to provide the sole support while moving the dishmachine 100, as a more stabilized support during transportation is preferred to reduce the chance the dishmachine tipping. It is particularly preferred that this aspect is to be considered a safety protocol within the operation of the device 100 to reduce injuries to the user or persons nearby. As such, additional stabilized support means are also provided and intended to be employed when transporting the dishmachine 100 engaged upon the device 10. Current, stabilized support means are provided by one or a plurality of slidable supports 40 which are slidably engaged to the side support rails 14 of the base frame 12.

It is intended that once the dishmachine 100 is lifted via the scissor jacks 22 to remove the pallet 200, the slidable supports 40 are positionable under the crossbars 104 such that when the dishmachine 100 is subsequently lowered, the slidable supports 40 are employed for supporting the crossbars 104, as shown in FIG. 6. As such the slidable supports 40 are preferably formed as reinforced and rigid durable bodies which can support the heavy weight of the dishmachine. In addition to providing stabilized support means during transportation, the slidable supports 40 allow the weight of the dishmachine 100 to be temporarily taken off the scissor jacks 22, which provides a means for ensuring a longer operable life of the scissor jacks 22 by reducing the load experienced on the jack linkage, and screw 30.

Now that the dishmachine 100 is fully supported on the device 10 the user can transport the dishmachine 100 to the desired location. Manufacturer installation requirements of the dishmachine 100 often dictates precise positioning. Often, such dishmachines must be placed with a minimum distances from a wall as needed for clearance and other safety protocol. It is noted that the positioning of the jacks 22 upon the base 12, and the overall length of the base 12 itself, may preclude the user from positioning the dishmachine 100 in a forward most location relative the base 12, as may be needed for final positioning. However the slidable engagement of the support rails 24 to the scissor jacks 22, and the slidable engagement of the supports 40 to the side rails 14 of the base frame 12, provides a means for translating the dishmachine 100 relative the base frame 12 as may be needed for positioning the dishmachine 100 to a final forward most location on the base frame 12. Thus, once finally positioned, the dishmachine 100 is lifted once again to allow removal of the slidable supports 40, and then lowered to the floor.

Also shown in FIG. 6 is an optional but preferred safety connector bar 50 which is positionably engageable between the push handle 20 and vertical support leg of the dishmachine 100 as a means for added securement thereof. Thus, the connector bar 50 reduces the chance of the dishmachine rocking or tipping when transporting the device 10 while pushing on the handle 20.

An additional particularly preferred feature of the device 10 is to mitigate injuries and ensure proper user protocol is followed, preferably through the employment of means for usage monitoring of the device 10. Currently, the means for usage monitoring is intended to track usage data including but not limited to, when the device 10 is used, how long it is used for, if correct safety protocols where followed (i.e. proper use of the slidable supports 40 during transportation), and determine the need for maintenance on the device 10 (i.e lubrication of the screw 30, replace a wheel 18, etc). A visual indicator 36 may be employed, for example including an array of lights which illuminate when a certain maintenance procedure is required.

In a particularly preferred mode, the device 10 is assigned an identification serial number or the like, which is linked to the user prior to an intended operation of the device 10. In FIG la, means for linking the device to the user can be provided by a RF microchip, bar code, or preferably a quick response (QR) code 38 which can be scanned and stored into a users handheld electronic device, such as a smart phone. Once linked, this data can be stored in the smart phone and sent over a wireless network to a remote server for data storage and retrieval if needed. In addition, sensing means 34, such as one or a combination of optical, position, or load sensors, can be incorporated into the hand crank 32 and screw 30 to measure the operation of the scissor jacks 22, including but not limited to, the date/time of operation, the distance raised or lowered (determined by rotations of the screw 30), and the load supported by the scissor jacks 22. This data may be stored in an onboard location the device 10. The device 10 may also employ a wireless network enabled communication means to send this data to the remote server.

In use, the remote server may be accessible to large equipment manufactures who have encountered law suits regarding workers compensation injuries related to lifting and transporting heaving equipment, such that they can retrieve usage data of the device employed to move such large equipment, and confirm if protocol was followed. For example, the monitoring means can be employed to determine if the device was for instance transported while the dishmachine was still supported by the scissor jacks by a recordation of a heavy load supported on the jacks during transportation of the device 10, which would indicate the sliding supports 40 were not used within the proper safety protocol of the device.

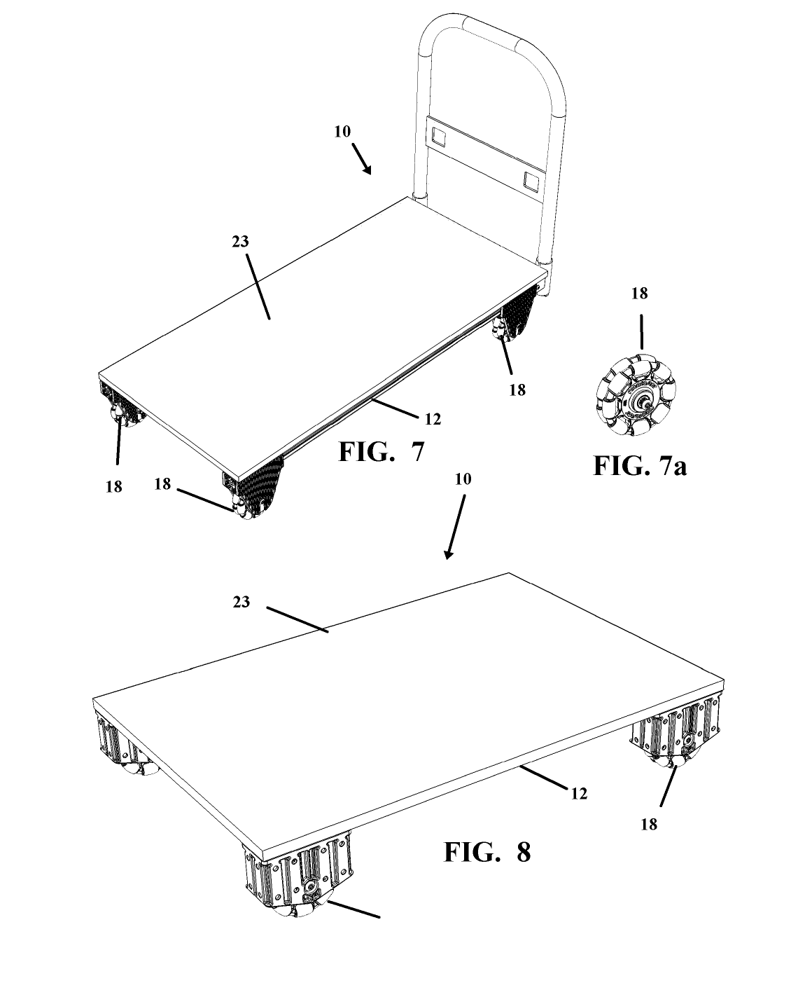

FIG. 7 depicts a mode of the device 10 shown as a cart having a frame 12 with omnidirectional wheels 18 and a planar top surface 23. So configured with the planar top surface 23 and omnidirectional wheels 10 and hand rail or not, the device 10 allows for placement of items on the planar top surface 23 and a rolling by imparting force to the cart in any direction since the wheels 18 rotate in two directions. The planar top surface 23 may be adapted on a bottom side to removably engage with the lift mechanism of FIGS. 1-3. Engagement points adapted for engagement to the scissor jacks 22 will allow for engagement or disengagement of the planar top surface 23 and allow raising the planar top surface 23 above the frame 12 by activation of the lift mechanism, to lift whatever resides on the planar top 23. In this mode, the planar top surface 23 can be removed, and the scissor lift 22 engaged to machinery or other objects adapted engage with it.

So engaged, the planar top surface 23 will remain level as shown in FIG. 3 since it would be engaged and rise in the same manner as depicted support rails 24. Even without the lift mechanism to raise the planar top surface 23 above the frame 12, the device 10 using omnidirectional wheels 18 is superior to existing carts in that it does not require one pair of wheels on casters so they rotate to steer. Instead, the device 10 can easily be manipulated in tight quarters by pushing either end in any direction and the wheels 18 will move the cart end in that direction.

FIG. 7a shows the omnidirectional wheels 18 showing side rolling sections providing the circumference in the direction of rotation of the entire wheel 18. Thus it will move sideways in the direction of its axle or around it.

FIG. 8 depicts a mover's dolly mode of the cart device 10. This mode too has a planar top surface 23 and omnidirectional wheels 18 and can be equipped with a lifting apparatus such as that in FIGS. 1-3 for lifting the planar top surface 23 level at all elevations. Just as in the device of FIG. 7, the lower side of the planar surface 23 adjacent the frame 12 will be adapted to engage with the lift mechanism of FIGS. 1-3 and will raise and lower in a level orientation using the scissor lift mechanism.

This invention has other applications, potentially, and one skilled in the art could discover these. The explication of the features of this invention does not limit the claims of this application; other applications developed by those skilled in the art will be included in this invention.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. A cart apparatus, comprising:
a frame;
four omnidirectional wheels projecting from a lower side of said frame for supporting said frame on a surface; and
a planar surface positioned on an upper side of said frame, opposite said lower side.

2. The cart of claim 1 additionally comprising:
a lifting mechanism engaged between a lower side of said planar surface and said frame; and
said lifting mechanism providing means to elevate said planar surface a distance above said frame.

3. The cart of claim 2 additionally comprising:
said lifting mechanism being a scissor lift powered by a rotating gear.

4. The cart of claim 2 additionally comprising:
a vertically disposed member extending from a first end of said frame supporting a handle at an elevation above said planar surface;
said handle providing means for steering said cart by imparting force to said handle in a direction of motion desired of said cart.

5. The cart of claim 2 additionally comprising:
said planar top surface being adapted for a removable engagement with said lifting mechanism; and
said lifting mechanism adapted to engage objects or equipment with mating means for removable engagement, whereby said cart may transport objects situated on said planar top surface or removably engaged to said lifting mechanism with said planar top surface removed.
